(19) United States
(12) Patent Application Publication
(10) Pub. No.: US 2017/0303062 A1
(43) Pub. Date: Oct. 19, 2017

(54) METHOD FOR WIRELESSLY SYNCHRONIZING ELECTRONIC DEVICES

(71) Applicant: Xin Ren, Warren, NJ (US)

(72) Inventor: Xin Ren, Warren, NJ (US)

(21) Appl. No.: 15/456,556

(22) Filed: Mar. 12, 2017

Related U.S. Application Data
(60) Provisional application No. 62/278,411, filed on Jan. 13, 2016.

(51) Int. Cl. H04S 7/00; H04R 5/02; H04S 3/00; H04R 5/04

(52) U.S. Cl. CPC H04S 7/308; H04S 3/008; H04R 5/04; H04R 5/02; H04S 7/302; H04R 2420/07; H04S 2400/01; H04S 2400/15

(57) ABSTRACT

A method of wirelessly synchronizing a plurality of discrete electronic devices each having an audio input channel and audio output channel. The method comprises detecting an output injection parameter of the audio output channel of a first electronic device at the time when an audio signal is output by the audio output channel of the first electronic device; detecting an input injection parameter of the audio input channel of a first electronic device at the time when the audio signal is injected to the audio input channel of the first device; receiving an input injection parameter of the audio input channel of a second device; receiving an output injection parameter of the audio output channel of a second device; and determine a synchronization parameter for synchronizing the first electronic device and the second electronic device on the basis of the detected parameters and the receiving parameters of audio channels.

### RELATED APPLICATION

The present application claims the benefit of priority under 35 U.S.C. sctn 119 to U.S. Provisional Application No. 62/278,411, titled “Method to wirelessly synchronize electronic devices,” filed on Mar. 13, 2016, the entirety of which is incorporated herein by reference.

### FIELD OF THE INVENTION

The present application relates generally to a method of synchronizing electronic devices. More specifically, the present application is capable of precisely synchronizing electronic devices equipped with audio capabilities, such as mobile devices, desktop and laptop computers, smart TVs, and Bluetooth speakers.

### BACKGROUND OF THE INVENTION

In recent years, the use of the aforementioned devices has become increasingly widespread. When two or more of these electronic devices are situated in close proximity, e.g. in the same room, it is desirable to use their audio capabilities collaboratively, so that either better audio quality or new audio features can be realized. By way of example, binaural sound (also known as 3D sound) recording and playback are important for Virtual Reality applications; but due to audio component and form factor constraints, binaural sound is difficult to be produced or reproduced on a single device, even if such device is equipped with multiple microphones and/or speakers.

Interaural Time Difference (or ITD), which is the difference in arrival time of a sound between two ears of humans or animals, represents an important factor that affects how a sound may be perceived by a human or an animal. The maximum ITD for humans is approximately 500 microseconds. Humans can perceive the time difference of a small fraction of the maximum ITD. ITD is important in the localization of sounds, as the time difference provides a cue to the direction or angle of the sound source from the head. Consequently precise synchronization, characterized by a synchronization accuracy of less than the maximum ITD, of multiple microphones is required for binaural sound recording. Likewise, precise synchronization of multiple speakers is required for playback of binaural sound playback. Precise synchronization is also a requirement in other applications. By way of example, seamless animation across multiple display screens can be achieved with precise synchronization—to an observer, each screen acts in unison with other screens as if it were part of one single, larger display screen. By way of another example, devices such as smartphones and tablets equipped with cameras can capture videos and photos synchronously, and the output from each camera can subsequently be stitched/combined to form stereoscopic 3D and/or panoramic videos and photos. The synchronization accuracy required by the latter two use case examples is less stringent comparing to that of binaural audio recording and playback, but still beyond the capabilities of existing methods based on Wi-Fi, Bluetooth or Network Time Protocol.

While precise synchronization can often be achieved trivially in a hardwired setup, e.g. in a home theater system where two or more speakers are tethered to the main control unit through audio cables, it is still quite challenging for existing methods to wirelessly synchronize two discrete or independent electronic devices to a precision that is sufficient for binaural (3D) sound and/or for other applications.

Moreover, once initial precise synchronization is achieved, it is often required to precisely measuring the clock drift between audio channels of electronic devices, in order to maintain the synchronization. Clock drift refers to the fact that clocks used by these devices, in general, do not run at the same speed, and after some time they “drift apart,” causing the audio channels to gradually desynchronize from each other. This clock drift needs to be measured precisely, in order to correct its effects and maintain tight synchronization, without resorting to frequent re-synchronization of the devices involved. It is difficult, with existing methods, to detect the relative clock drift between two discrete or independent electronic devices wirelessly, especially when one or both devices are subject to movement (i.e. non-stationary) relative to each other, to a precision sufficient for certain applications, such as binaural (3D) sound.

### SUMMARY OF THE INVENTION

The present application discloses a method for synchronizing a plurality of electronic devices. The plurality of electronic devices are preferably close in distance to one another such as special sound effects or visual effects may be generated by the plurality of electronic devices. In one embodiment according to the present application, the achieved precision of synchronization is such that binaural sound recording can be made across multiple electronic devices that are not tethered (i.e. hard-wired), with each device recording or reproducing a separate audio stream. In another embodiment, the level of precision also enables the faithful reproduction of a pre-recorded binaural sound recording across multiple electronic devices, with each device playing a separate audio stream of the recording. Once synchronized and once a trigger event has occurred, each electronic device is able to start emitting or recording sound through its audio subsystem, in such a way that the time difference of the start of playback or recording of sound between any two devices is significantly less than the maximum human ITD.

The present application also discloses method for measuring relative clock drift between multiple electronic devices, that may or may not be stationary relative to each other. Based on the clock drift measurement, audio samples can be discarded or inserted into the audio input or output streams on either or both devices, such that synchronization is maintained. The accuracy achieved by this method is such that binaural sound recording and playback can be made across multiple electronic devices on a continuous basis without loss of initial synchronization.

An aspect of the present application is directed to a method of wirelessly synchronizing a plurality of discrete electronic devices each having an audio input channel and audio output channel. The method comprises providing a wireless communication channel among the plurality of electronic devices; detecting an output injection parameter of the audio output channel of a first electronic device at the time when an audio signal is output by the audio output channel of the first electronic device; detecting an input injection parameter of the audio input channel of a first electronic device at the time when the audio signal is injected to the audio input channel of the first device; receiving an input injection parameter of the audio input channel of a second device; receiving an output injection parameter of the audio output channel of a second device; and determine a synchronization parameter for synchronizing the first electronic device and the second electronic device on the basis of the detected parameters and the receiving parameters of audio channels. According to various embodiments, the input injection parameter includes a sample number. The method further comprises detecting sample frequencies of the audio channels of the first and second electronic devices; and determining the synchronization parameter on the basis of the sample frequencies. The method further comprises generating a 3D audio signal based on the synchronization parameter. The method further comprises recording a 3D audio signal based on the synchronization parameter. Another aspect of the present application is directed to a method of determining the clock drift between a first electronic device and a second electronic device. The method comprises injecting a plurality of audio signals to the audio output channel of a first device and detecting injection parameters of the plurality of audio signals at the time when the plurality of audio signals are injected to the audio output channel of the first device; detecting injection parameters of the plurality of audio signals at the time when the plurality of audio signals are injected to the audio input channel of the second device; injecting a plurality of audio signals generated by the second device into the audio input channel of the first device and detecting injection parameters at the time when the plurality of audio signals generated by the second device are injected into the audio input channel of the first device, injecting the plurality of audio signals generated by the second device into the audio input channel of the second electronic device and detecting injection parameters at the time when the plurality of audio signals generated by the second electronic device are injected into the audio input channel of the second electronic device; and determining a clock drift between the first electronic device and the second electronic device based on the detected injection parameters. According to various embodiment, the injection parameter includes a sample number. The plurality of audio signals include four audio signals. The first electronic device and the second electronic device generate the plurality of audio signals alternately. The two electronic devices are relatively stationary to each other. The two electronic devices are subject to movement to each other.

An advantage that may be achieved by the methods as set forth in the present application is that, according to particular embodiments, it does not require nor involve the use or assistance of any external system or apparatus, e.g. a server or a signal generation apparatus, that is not present on the electronic devices to implement these disclosed synchronization methods (i.e., offline in nature).

In another embodiment, the methods as disclosed in the present application may be implemented by hardware or software. When software is used for carrying out the methods, a non-transitory medium may be used to record an executable program that, when executed, causing a computer or a processor to implement the synchronization methods as disclosed in the present application.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram showing an exemplary setup of two electronic devices situated nearby, according to one embodiment;

FIG. 2 is a diagram showing the process of determining the relative timing of audio subsystem of electronic devices, according to one embodiment;

FIG. 3 is a diagram showing an exemplary setup of a plurality of (>2) electronic devices situated nearby, according to one embodiment;

FIG. 4 is a diagram showing the process of determining the relative clock drift of audio subsystem of stationary electronic devices, according to one embodiment;

FIG. 5 is a diagram showing the process of determining the relative clock drift of audio subsystem of electronic devices, without restriction on device movement, according to one embodiment;

FIG. 6 is a diagram showing an alternative process of determining the relative clock drift of audio subsystem of electronic devices, without restriction on device movement, according to another embodiment;

### DETAILED DESCRIPTION

In the following detailed description, numerous specific details are set forth by way of examples in order to provide a thorough understanding of the relevant teachings. However, it should be apparent that the present teachings can be practiced without such details or with an equivalent arrangement. In other instances, well known methods, procedures, components, and/or circuitry have been described at a relatively high-level, without detail, in order to avoid unnecessarily obscuring aspects of the present teachings.

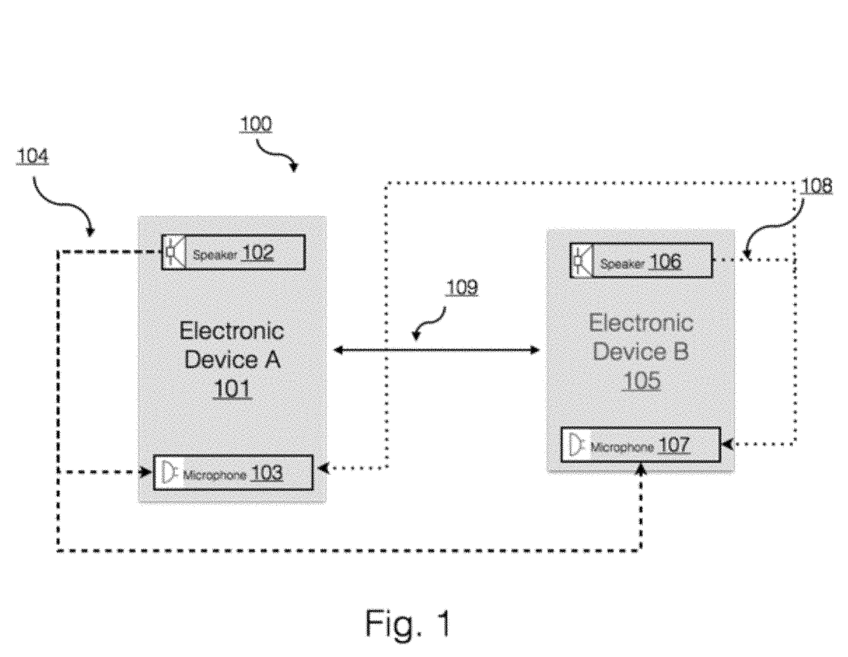

FIG. 1 is a diagram showing an exemplary synchronization system that has two electronic devices situated nearby, according to one embodiment. Electronic device A 101 is equipped with at least one speaker 102 and at least one microphone 103. Similarly electronic device B 105 is equipped with at least one speaker 106 and at least one microphone 107.

According to one embodiment, steps to obtain precise synchronization between electronic device A 101 and electronic device B 105 are comprised of:
establishing a direct communication link 109 between devices A 101 and B 105;
devices A 101 and B 105 starting audio recording through microphones 103 and 107, respectively and separately;
electronic device A 101 sending an acoustic signal 104 through its speaker 102;
electronic devices A 101 and B 105 detecting start time of said acoustic signal 104 received by microphones 103 and 107, respectively and separately;
device B 105 sending an acoustic signal through its speaker 106 upon detecting acoustic signal 104 from device A 101;
devices A 101 and B 105 detecting start time of said acoustic signal 106 through microphones 103 and 107, respectively and separately;
devices A 101 and B 105 exchanging certain information about detected acoustic signals 104 and 106 over the communication link 109, and
determining a synchronization parameter by one electronic device according to the information provided by the other electronic device.
   Information being exchanged and the processing of such information will be described in detail in the following sections of the present application.

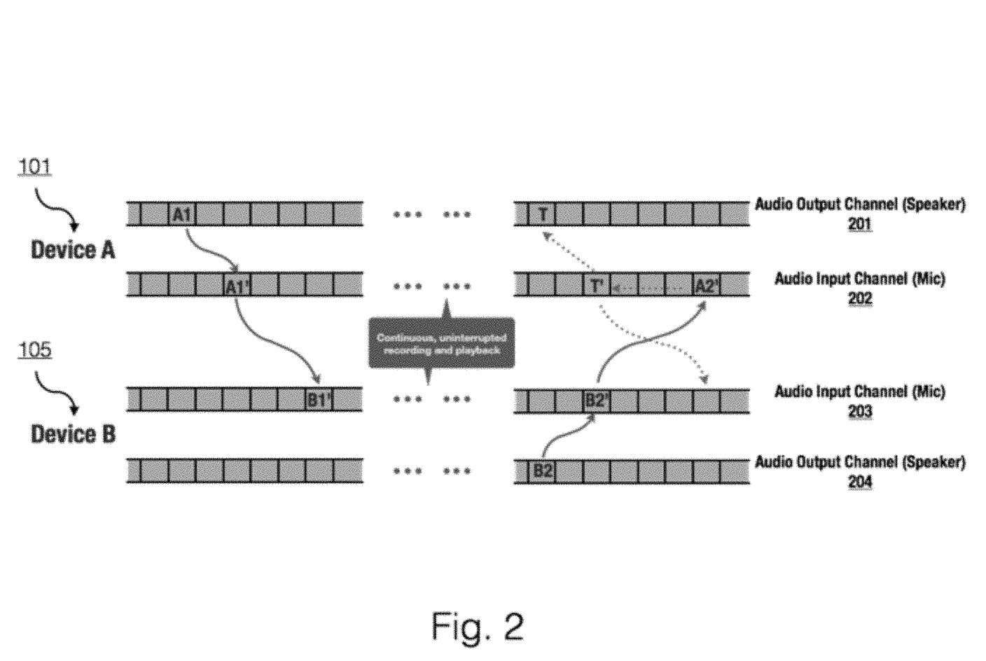

Referring now to FIG. 2, the audio channels of system 100 inlcude digitized samples of audio output channel (speaker) 201, audio input channel (microphone) 202 of device A 101, and digitized samples of audio input channel (microphone) 203, audio output channel (speaker) 204 of device B 102. Each of the electronic device is capable of detecting an input sample number and an output sample number of its own audio channels. For example, the acoustic signal 104 is injected into audio output channel (speaker) 201 of device A 101 starting at sample number A1. It is detected by device A 101 on its audio input channel (microphone) 202 as starting at sample number A1_prime; It is also detected by device B 105 on its audio input channel (microphone) 203 as starting at sample number B1_prime. After device B 105 detects the acoustic signal 104, the acoustic signal 108 is injected into audio output channel (speaker) 204 of device B 105 starting at sample number B2. It is detected by device B 105 on its audio input channel (microphone) 203 as starting at sample number B2_prime; It is also detected by device A 101 on its audio input channel (microphone) 202 as starting at sample number A2_prime.

It is noted that the sample numbers on the audio input/output channels 201, 202, 203, and 204 are independent of one another, and are incremented relative to their respective and in general, different starting points. In one embodiment, the synchronization method according to the present application determines a sample number T, on device A 101's audio output channel (speaker) 201, that corresponds in time to sample number B2 on device B 105's audio output channel (speaker) 204. The method also determines a sample number T_prime, on device A 101's audio input channel (microphone) 202, that corresponds in time to sample number B2_prime on device B 105's audio input channel (microphone) 203.

According to one embodiment, sample number T on device A 101's audio output channel (speaker) 201 is calculated according to the following formula:

T=[(A2_prime−A1_prime)+(B2_prime−B1_prime)*Sa/Sb]/2+A1,

wherein Sa is audio channel sampling frequency used by device A 101, and Sb is audio channel sampling frequency used by device B 105.
According to one embodiment, sample number T_prime on device A 101's audio input channel (microphone) 202 is calculated according to the following formula:

T_prime=T−A1+A1_prime.

According to one embodiment, device B 105 supplies Sb, B2_prime and B1_prime to device A 101 over the communication channel 109, in order for device A 101 to apply the aforementioned formula. According to another embodiment, device B 105 supplies the Sb, and difference between B2_prime and B1_prime, in order for device A 101 to apply the aforementioned formula.

Once device A 101 obtains T, devices A 101 and B 105 are considered to be in synchronization with each other in terms of audio output. According to one embodiment, in response to a trigger event, e.g. a user pressing a “play” button on the User Interface of a music application, device A 101 chooses a sample number Tp, and injects an audio stream to its audio output channel (speaker) 201 starting at Tp. Device A 101 also calculates the difference between Tp and T, i.e., D1=Tp−T, and send D1 along with Sa to device B 105 over the communications channel 109. Device B 105 then injects an audio stream to its auto output channel (speaker) 204 starting at the following sample number:

B2+D1*Sb/Sa.

In this way, the audio streams output by devices A 101 and B 105 are considered to be in synchronization with each other. The synchronization method is capable of reducing signal difference produced by these devices down to one sample interval. For example, for a commonly used audio channel sampling frequency of 44.1 kHz in electronic devices, the synchronization resolution is the duration of one digitized sample, or approximately 23 microseconds.

The method disclosed in the present application may also be used for synchronization when a plurality of electronic devices are recording audio signals. Once device A 101 obtains T_prime, devices A 101 and B 105 are considered to be in synchronization with each other in terms of audio input. According to one embodiment, in response to a trigger event, e.g. a user pressing a “record” button on the User Interface of a recording application, device A 101 chooses a sample number Tr, and starts to record an audio stream through its audio input channel (microphone) 202 starting at Tr. Device A 101 also calculates the difference between Tr and T_prime, i.e., D2=Tr−T_prime, and sends D2 along with Sa to device B 105 over the communications channel 109. Device B 105 then starts recording an audio stream through its auto input channel (microphone) 203 starting at sample number B2_prime+D2*Sb/Sa. The audio streams captured by devices A 101 and B 105 will be in synchronization with each other. For a commonly used audio channel sampling frequency of 44.1 kHz in electronic devices, the synchronization resolution is the duration of one digitized sample, or approximately 23 microseconds.

While the information exchanged between electronic devices and method employed to process the information have been described in accordance with the depicted embodiment of FIG. 2, it is contemplated that many equivalent arrangements may be used. For example, a correspondence between sample numbers other than B2 and T can be derived, if they are equal in distance from B2 and T, respectively. For another example, instead of sending D1 and Sa to device B 105, device A 101 can convert D1 into absolute time based on its sampling frequency, before sending it to device B 105, which will convert it back to a duration in samples based on its own sampling frequency. For yet another example, device B 105 may initiate recording or playback of sound after synchronization, instead of device A 101, by following similar steps as described above.

While system 100 and synchronization steps have been described in accordance with the depicted embodiment of FIG. 1, it is contemplated that system 100 may embody many forms and include alternative components. According to one embodiment, instead of a direct communication link 109, an indirect communication link can be established between device A 101 and device B 105, for example, through a server. According to another embodiment, a communication link (either direct or indirect) is established any time during the synchronization procedure before the electronic devices exchange information. According to another embodiment, any other component that is capable of producing an acoustic signal on either or both of the electronic devices is used in lieu of speakers 102 or 106. By way of example and not by way of limitation, this can be a haptics actuator vibrating at any frequency. According to yet another embodiment, one or both of the electronic devices is(are) connected physically or wirelessly to device(s) that is(are) capable of producing an acoustic signal, and the said device(s) is(are) used in lieu of a speaker. By way of example and not by way of limitation, this can be an external speaker connected to one or both of the electronic devices through a headphone jack.

In the foregoing sections, we described methods to wireless synchronize two electronic devices in close proximity to each other. We now turn to the case wherein multiple (>2) devices nearby need to be synchronized.

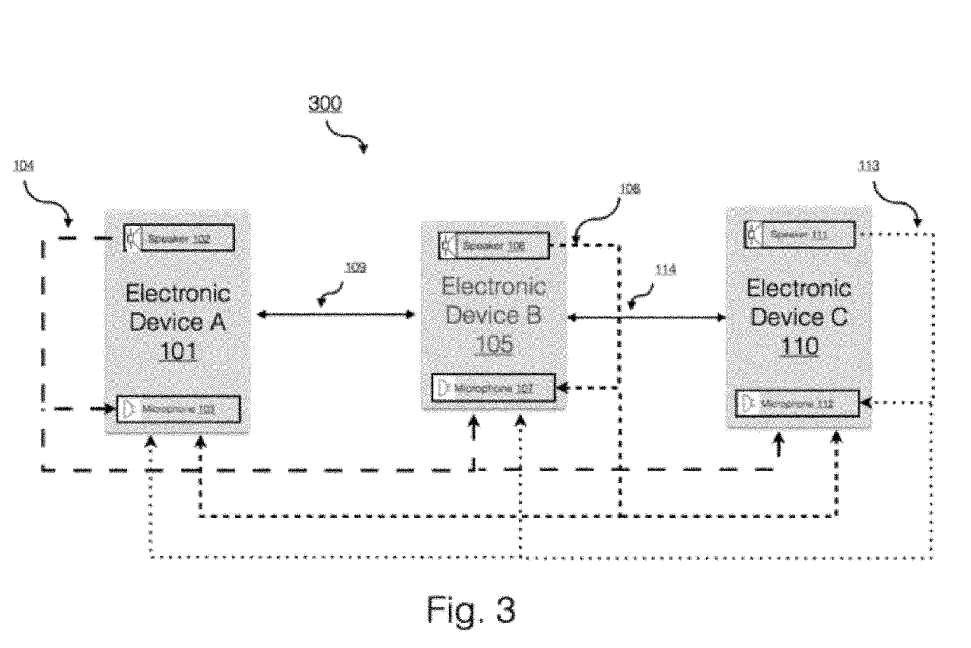

Refer now to FIG. 3, wherein an exemplary setup involving 3 devices is depicted. In one embodiment, the three devices may be synchronized pairwisely, e.g. synchronize device A 101 and device B 105 first, then synchronize device B 105 and device C 110.

In another embodiment, the three devices may be synchronized collectively.

The synchronization steps include similar processing as those in the two devices case, except for the following. When each device sends an acoustic signal through its audio output channel (104, 108, 113), itself and all other devices are recording and detecting said signal in their respective audio input channel (microphone) (103, 107, 112). Each device reports detected sample numbers or the difference between sample numbers to relevant devices. Here a “relevant device” refers to the device that generated the corresponding acoustic signals in the report. According to one embodiment, each device employs different acoustic signal characteristics so that another device can distinguish from which device an acoustic signal is originated. In addition, it is preferable to avoid two or more devices sending acoustic signals that overlap in time which may cause interference. According to one embodiment, a time-division approach can be taken, wherein each device has an assigned time slot to send its acoustic signal. According to another embodiment, a carrier sensing and random backoff mechanism can be employed.

While we used 3 devices as an example, it is apparent that the same method described in in the previous sections can be extended to apply to a greater number (>3) of devices.

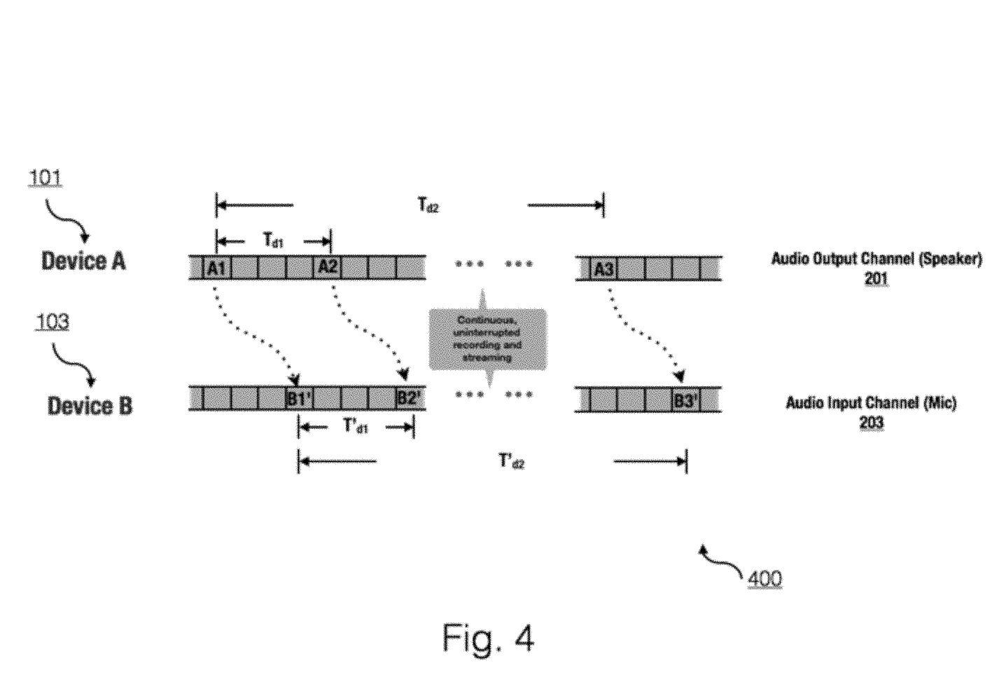

Referring to FIG. 4, a diagram showing the process of determining the relative clock drift of audio subsystem of electronic devices that are stationary relative to each other, in which digitized samples of audio output channel (speaker) 201 of electronic device A 101, as well as digitized samples of audio input channel (microphone) 203 of electronic device B 105, are illustrated. An acoustic signal is injected into audio output channel (speaker) 201 of device A 101 starting at sample number A1. It is detected by device B 105 on its audio input channel (microphone) 203 as starting at sample number B1′. After a predetermined and fixed time delay T_{d1}, a second acoustic signal is injected into audio output channel (speaker) 201 of device A 101 starting at sample number A2=T_{d1}*S_{A}+A1 where S_{A} is the sampling frequency employed by device A 101. The said second acoustic signal is detected by device B 105 on its audio input channel (microphone) 203 as starting at sample number B2′. As devices 101 and 105 remain stationary relative to each other, it may be understood that the time difference between B1′ and B2′, T′_{d1}=(B2′−B1′)/S_{B}, where S_{B} is the sampling frequency employed by device B 105, can be attributed entirely to the sum of time delay between A1 and A2, T_{d1}, and drift that has occurred between the clocks. Therefore, the drift rate of device B 105's audio clock relative to device A 101's audio clock may be calculated as CD_{AB}=(T′_{d1}−T_{d1})/T_{d1}. Similarly the drift rate of device A 101's audio clock relative to device B 105's may be calculated as CD_{BA}=(T_{d1}−T′_{d1})/T′_{d1}. Parts per Million (ppm) is the standard unit for clock drift rate, and to convert CD_{AB} and CD_{BA} to ppm we use the following formulae:

PPM_{AB}=CD_{AB}*1000000 , PPM_{BA}=CD_{BA}*1000000.

It is desirable to obtain an accurate estimate of the clock drift as quickly as possible, which entails choosing T_{d1} to be as small as possible. Depending on clock crystals and circuits used in each device, the relative clock drift can range from less than 1 ppm for TCXO-driven clocks to more than 100 ppm for typical crystal-driven clocks. As it is generally not known a priori the approximate range of the clock drift between any given pair of devices, T_{d1} may be set too small to obtain an accurate estimate in some cases. By way of example, assuming a sampling frequency of 48 KHz used by both devices (i.e. 20.8 μs for each digitized audio sample), and T_{d1} set to 10 seconds. Further assuming measured time difference between T_{d1} and T′_{d1} to be 104 μs (i.e. 5 samples), in which case the clock drift rate is calculated to be 10.4 ppm. Because the time difference measurement has the resolution or granularity of 1 sample, this result can be off by 20%, or in other words, the true clock drift rate can fall in the range between 8.3 ppm to 12.5 ppm. A coarse-to-fine approach is therefore contemplated to solve this issue, with steps comprised of:
choosing a T_{d1} and following the procedure described in previous sections to obtain absolute value of the drift, AD=abs(T_{d1}−T′_{d1});
calculating the ratio of the duration of one sample to AD;
if it is less than a preset threshold (for example, 10%), declaring that an accurate estimate of clock drift has been obtained;
otherwise, choosing a T_{d2}>T_{d1}, such that the ratio of the duration of one sample to AD, divided by the ratio of T_{d2} to T_{d1}, is less than the preset threshold;
injecting a third acoustic signal into audio output channel (speaker) 201 of device A 101 starting at sample number A3=T_{d2}*SA+A1; the said third acoustic signal being detected by device B 105 on its audio input channel (microphone) 203 as starting at sample number B3′;
finally T′_{d2}=(B3′−B1′)/SB, and T_{d2} and T′_{d2} are now used in lieu of T_{d1} and T′_{d1} for the clock drift calculation.

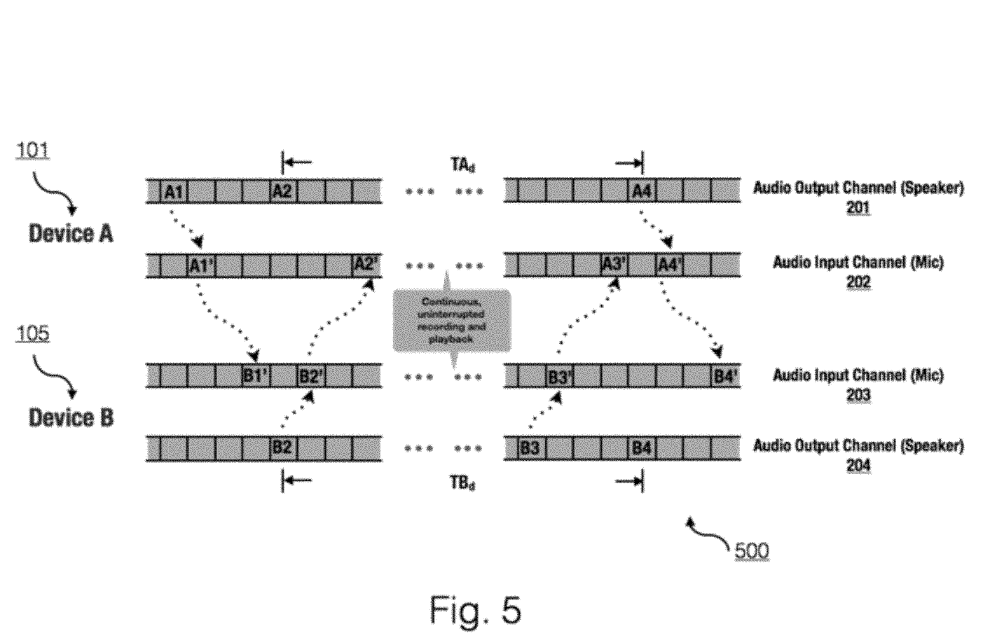

Referring now to FIG. 5, a diagram shows the process of determining the relative clock drift of audio subsystem of electronic devices, without restriction on device movement, according to one embodiment. Digitized samples of audio output channel (speaker) 201 and audio input channel (microphone) 202 of electronic device A 101, as well as digitized samples of audio output channel (speaker) 204 and audio input channel (microphone) 203 of electronic device B 105, are illustrated. Four acoustic signals are shown, they are:
1) a first acoustic signal injected into audio output channel (speaker) 201 of device A 101 starting at sample number A1, which is detected by the same device on the audio input channel (microphone) 202 as starting at sample number A1′ and by device B 105 on its audio input channel (microphone) 203 as starting at sample number B1′;
2) a second acoustic signal injected into audio output channel (speaker) 204 of device B 105 starting at sample number B2, which is detected by the same device on the audio input channel (microphone) 203 as starting at sample number B2′ and by device A 101 on its audio input channel (microphone) 202 as starting at sample number A2′;
3) a third acoustic signal injected into audio output channel (speaker) 204 of device B 105 starting at sample number B3, which is detected by the same device on the audio input channel (microphone) 203 as starting at sample number B3′ and by device A 101 on its audio input channel (microphone) 202 as starting at sample number A3′; and
4) a fourth acoustic signal injected into audio output channel (speaker) 201 of device A 101 starting at sample number A4, which is detected by the same device on the audio input channel (microphone) 202 as starting at sample number A4′ and by device B 105 on its audio input channel (microphone) 203 as starting at sample number B4′. Note that the sample numbers on the audio input/output channels 201, 202, 203, and 204 are independent of one another, and are incremented relative to their respective and in general, different starting points.

The time elapsed between the first and second acoustic signals and between the third and fourth acoustic signals are controlled to be sufficiently small such that the two devices 101 and 105 can be considered stationary relative to each other in between the issuance of said signals. It is noted that the time elapsed between the second and third acoustic signals can be arbitrary, and the relative position of devices 101 and 105 can change during this time period.

According to one embodiment, sample number A2 on device A 101's audio output channel (speaker) 201 is calculated according to the following formula:

A2=[(A2′−A1′)+(B2′−B1′)]/2+A1;

sample number B4 on device B 105's audio output channel (speaker) 204 is calculated according to the following formula:

B4=[(A4′−A3′)+(B4′−B3′)]/2+B3.

Time difference between A2 and A4, is calculated as

TA_{d}=(A4−A2)/S_{A,}

and time difference between B2 and B4 is calculated as

TB_{d}=(B4−B2)/S_{B}.

The drift rate of device B 105's audio clock relative to device A 101's is calculated as

CD_{AB}=(TB_{d}−TA_{d})/TA_{d}.

Similarly the drift rate of device A 101's audio clock relative to device B 105's is calculated as

CD_{BA}=(TA_{d}−TB_{d})/TB_{d}.

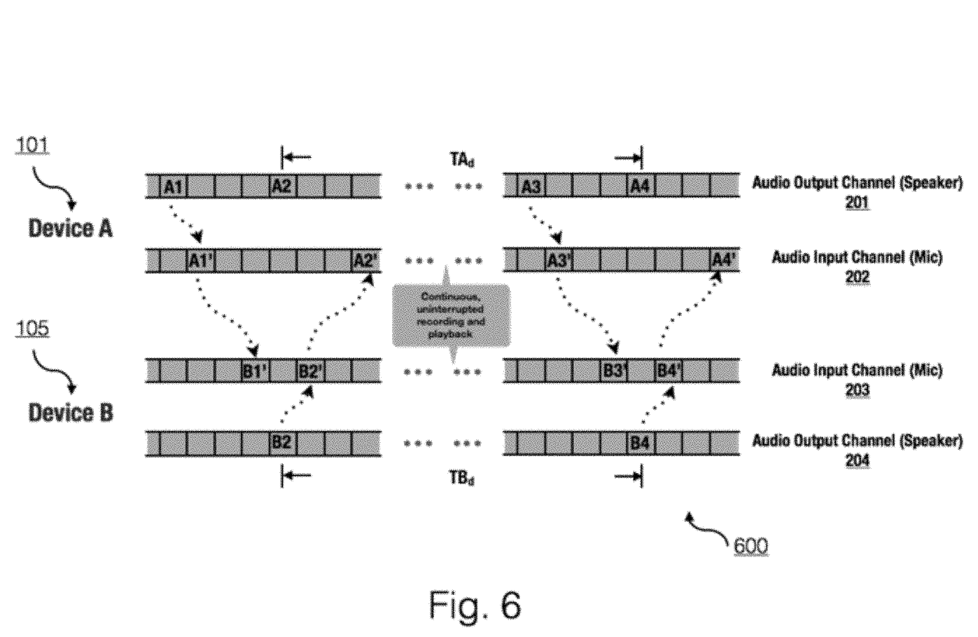

Referring now to FIG. 6, a diagram shows an alternative process of determining the relative clock drift of audio subsystem of electronic devices, without restriction on device movement, according to one embodiment. Digitized samples of audio output channel (speaker) 201 and audio input channel (microphone) 202 of electronic device A 101, as well as digitized samples of audio output channel (speaker) 204 and audio input channel (microphone) 203 of electronic device B 105, are illustrated. Four acoustic signals are shown, they are
1) a first acoustic signal injected into audio output channel (speaker) 201 of device A 101 starting at sample number A1, which is detected by the same device on the audio input channel (microphone) 202 as starting at sample number A1′ and by device B 105 on its audio input channel (microphone) 203 as starting at sample number B1′;
2) a second acoustic signal injected into audio output channel (speaker) 204 of device B 105 starting at sample number B2, which is detected by the same device on the audio input channel (microphone) 203 as starting at sample number B2′ and by device A 101 on its audio input channel (microphone) 202 as starting at sample number A2′;
3) a third acoustic signal injected into audio output channel (speaker) 201 of device A 101 starting at sample number A3, which is detected by the same device on the audio input channel (microphone) 202 as starting at sample number A3′ and by device B 105 on its audio input channel (microphone) 203 as starting at sample number B3′; and
4) a fourth acoustic signal injected into audio output channel (speaker) 204 of device B 105 starting at sample number B4, which is detected by the same device on the audio input channel (microphone) 203 as starting at sample number B4′ and by device A 101 on its audio input channel (microphone) 202 as starting at sample number A4′. Note that the sample numbers on the audio input/output channels 201, 202, 203, and 204 are independent of one another, and are incremented relative to their respective and in general, different starting points.

The time elapsed between the first and second acoustic signals and between the third and fourth acoustic signals are controlled to be sufficiently small such that the two devices 101 and 105 can be considered stationary relative to each other in between the issuance of said signals. It is noted that the time elapsed between the second and third acoustic signals can be arbitrary, and the relative position of devices 101 and 105 can change during this time period.

According to one embodiment, sample number A2 on device A 101's audio output channel (speaker) 201 is calculated according to the following formula:

A2=[(A2′−A1′)+(B2′−B1′)]/2+A1;

sample number A4 is calculated according to the following formula:

A4=[(A4′−A3′)+(B4′−B3′)]/2+A3.

Time difference between A2 and A4, is calculated as

TA_{d}=(A4−A2)/S_{A}, and

time difference between B2 and B4 is calculated as

TB_{d}=(B4−B2)/S_{B}.

The drift rate of device B 105's audio clock relative to device A 101's is calculated as

CD_{AB}=(TB_{d}−TA_{d})/TA_{d}.

Similarly the drift rate of device A 101's audio clock relative to device B 105's is calculated as

CD_{BA}=(TA_{d}−TB_{d})/TB_{d}.

In a manner similar to that described in previous sections of the present application, if the time delay between the second and third acoustic signals is not adequate to obtain an accurate estimate of the clock drift, due to the measurement resolution which is the duration of one audio sample, a larger time delay can be chosen and two more acoustic signals can be issued, and the procedures as described in previous sections can be carried out using the timing of the fifth signal in place of the third signal and the sixth signal in place of the fourth.

A typical electronic device contains multiple clocks, driven by separate crystal oscillators. By way of example, a different clock than the one for the audio subsystem is used by the Operating System of an electronic device. Although the aforementioned methods apply to measuring the relative clock drift between the audio clocks of different devices, it is contemplated that they can be extended to measure the relative clock drift between other clocks, e.g. between the OS clocks. This is achieved, by way of example and not by way of limitation, by first measuring on each device the clock drift between the audio clock and the other clock that is of interest, then combine the results in a straightforward manner.

While the present invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and any equivalents thereto.

What is claimed is:

1. A method of wirelessly synchronizing a plurality of discrete electronic devices each having an audio input channel and audio output channel, the method comprising:
providing a wireless communication channel among the plurality of electronic devices;
detecting an output injection parameter of the audio output channel of a first electronic device at the time when an audio signal is output by the audio output channel of the first electronic device;
detecting an input injection parameter of the audio input channel of a first electronic device at the time when the audio signal is injected to the audio input channel of the first device;
receiving an input injection parameter of the audio input channel of a second device;
receiving an output injection parameter of the audio output channel of a second device; and
determine a synchronization parameter for synchronizing the first electronic device and the second electronic device on the basis of the detected parameters and the receiving parameters of audio channels.

2. The method of claim 1, wherein the input injection parameter includes a sample number.

3. The method of claim 1, further comprising:
detecting sample frequencies of the audio channels of the first and second electronic devices; and
determining the synchronization parameter on the basis of the sample frequencies.

4. The method of claim 1, further comprising:
generating a 3D audio signal based on the synchronization parameter.

5. The method of claim 1, further comprising:
recording a 3D audio signal based on the synchronization parameter.

6. A method of determining the clock drift between a first electronic device and a second electronic device, the method comprising:
injecting a plurality of audio signals to the audio output channel of a first device and detecting injection parameters of the plurality of audio signals at the time when the plurality of audio signals are injected to the audio output channel of the first device;
detecting injection parameters of the plurality of audio signals at the time when the plurality of audio signals are injected to the audio input channel of the second device;
injecting a plurality of audio signals generated by the second device into the audio input channel of the first device and detecting injection parameters at the time when the plurality of audio signals generated by the second device are injected into the audio input channel of the first device,
injecting the plurality of audio signals generated by the second device into the audio input channel of the second electronic device and detecting injection parameters at the time when the plurality of audio signals generated by the second electronic device are injected into the audio input channel of the second electronic device; and
determining a clock drift between the first electronic device and the second electronic device based on the detected injection parameters.

7. The method of claim 5, wherein the injection parameter includes a sample number.

8. The method of claim 5, wherein the plurality of audio signals include four audio signals.

9. The method of claim 5, wherein the first electronic device and the second electronic device generate the plurality of audio signals alternately.

10. The method of claim 5, wherein the two electronic devices are relatively stationary to each other.

11. The method of claim 5, wherein the two electronic devices are subject to movement relative to each other.
